(19) United States
(12) Patent Application Publication
(10) Pub. No.: US 2024/0167436 A1
(43) Pub. Date: May 23, 2024

(54) GASEOUS FUEL INJECTOR

(71) Applicant: Stanadyne Operating Company LLC, Jacksonville, NC (US)

(72) Inventors: Bradlee J. Stroia, West Bloomfield, MI (US); David L. Eastman, Canton, MI (US)

(21) Appl. No.: 18/517,586

(22) Filed: Nov. 22, 2023

Related U.S. Application Data
(60) Provisional application No. 63/427,331, filed on Nov. 22, 2022.

(51) Int. Cl. F02M 21/02; F02M 51/06; F02M 63/00

(52) U.S. Cl. CPC F02M 21/0254; F02M 21/0275; F02M 51/0603; F02M 63/0077; F02M 2200/9015

(57) ABSTRACT

A fuel injector for controlling delivery of gaseous fuel into an intake passage of an internal combustion engine defines a fuel flow passage extending in a direction of fuel flow from an inlet to an outlet. An actuator moves a normally closed valve member from a closed to an open position. An annular valve seat is inclined relative to a direction of fuel flow, causing gaseous fuel to flow against the direction of fuel flow and act on the valve member in an opening direction when said actuator is energized to move the valve member to the open position. The valve member includes an extension including helical ribs defining helical channels, the helical ribs bearing on an inside surface of an outflow passage to guide axial movement of the valve member and said helical channels imparting a centripetal acceleration to said gaseous fuel as it flows through the outflow passage.

### FIELD OF THE INVENTION

In current state of the art propulsion systems, high flow gaseous valves are needed to supply the engine with the necessary fuel for operation. This invention describes a novel method for delivering the flow to the engine in a very efficient and low restrictive manner. The design contains a “flow balance” feature, that greatly reduces the flow forces acting on the valve. The invention also contains a novel swirl feature, which will increase and enhance the mixing and flow to the engine.

### BACKGROUND OF THE INVENTION

Utilization of gaseous fuels such as hydrogen or methane as homogeneous charge fuels in place of gasoline presents a challenge to deliver gaseous fuel and air to an internal combustion engine in quantities sufficient to generate the equivalent energy output realized from existing gasoline and diesel fuels. Gasoline and diesel fuels have a much greater energy density by volume than gaseous fuels such as hydrogen and methane, which allows much smaller quantities of fuel to generate acceptable engine power and torque. Substitution of such cleaner burning and potentially more plentiful gaseous fuels in place of liquid fuels such as gasoline and diesel require supplying a large volume of gaseous fuel in a short period of time. Previous attempts to design fuel injection valves to supply gaseous fuels encounter issues of turbulence and “choking” under high gaseous flow that do not permit sufficient gaseous fuel delivery in the short period of time available during the intake stroke of the engine.

While gaseous fuels have the potential to be clean burning, to control generation of nitrogen oxides (NOX), it is necessary to ensure that combustion occurs in the presence of excess oxygen. Operation at excess oxygen equivalence ratios requires greater air entry, and combustion chamber heads often have two or three intake valves and two or three exhaust valves. This leaves very little room in the head area for a direct cylinder fuel injector or a spark plug. Operation of higher speed valves by overhead camshafts further complicates and reduces the space available for direct cylinder fuel injectors and spark plugs.

Therefore, it is extremely difficult to deliver by any conduit greater in cross-section than the gasoline engine spark plug or the diesel engine fuel injector equal energy by alternative fuels such as hydrogen, methane, propane, butane, ethanol, or methanol, all of which have lower energy values per volume than gasoline or diesel fuel.

### SUMMARY OF THE INVENTION

A gaseous fuel injector valve for delivering gaseous fuel to an air intake of an internal combustion engine is disclosed. Delivery of fuel to the air intake of an internal combustion engine may also be described as port fuel injection (PFI) and the discloses fuel injector can be used as a port fuel injector. Components of the fuel injector are configured to serve more than one function, resulting in a fuel injector having a reduced part count and simplified assembly. The valve structure is pressure balanced, such that gaseous fuel pressure is used to assist in maintaining valve closure and when the valve is opened, to assist in completing opening movement of the valve. A pressure balanced valve design reduces the force needed to close and open the valve, allowing reduced actuation force from a solenoid or other actuator. The disclosed fuel injector includes features downstream of a valve seat that impart a swirling motion to gaseous fuel passing through the valve, which enhances mixing of the gaseous fuel with air in the intake path.

The fuel injector includes a sealed injector body defining a fuel flow passage extending in a direction of fuel flow from an inlet to an outlet. A valve member is arranged within the injector body and is moved between a closed position and an open position by an actuator. The valve member includes an annular valve member surface mating with an annular valve seat surface in the closed position. An annular valve seat is positioned in a valve chamber has a valve seat surface inclined at an acute angle relative to the direction of fuel flow and longitudinal axis of the fuel injector. The valve member defines a fuel flow passage between an inlet of the fuel injector and the valve chamber, allowing pressurized gaseous fuel in the valve chamber to act on the valve member to bias the valve member toward the valve seat when the valve member is in the closed position. The angle of inclination of the valve seat surface causes gaseous fuel to flow against the direction of fuel flow and act on the valve member in an opening direction when the valve member is in the open position. The valve member includes an extension projecting into an outflow passage downstream of the valve seat, the extension having an outside surface including a plurality of helical ribs defining a plurality of helical channels. The helical ribs bear on an inside surface of the outflow passage to guide movement of the valve member and the helical channels impart a centripetal acceleration to gaseous fuel as it flows through the outflow passage. The outflow passage has a first diameter D1 immediately downstream of the valve seat surface, and a second diameter D2 smaller than the first diameter D1 downstream of the first diameter D1.

In some embodiments, the valve seat surface is a conical surface and the valve member surface is a conical surface concentric with said valve seat surface. The conical valve seat surface may be oriented at an acute angle relative to a longitudinal axis of the fuel injector, the acute angle measured in the direction of fuel flow. In another embodiment, the valve member surface is a conical surface is oriented at a first acute angle relative to a longitudinal axis of the fuel injector and the valve seat surface is a conical surface oriented at a second acute angle relative to the longitudinal axis of the fuel injector, the first acute angle being greater than the second acute angle, the valve member surface meeting said valve seat surface at a sealing line. In an alternative configuration, the valve member surface is an annular surface having a large radius of curvature in a plane parallel to the longitudinal axis of the fuel injector, the valve member surface meeting the valve seat surface at a sealing line.

The fuel injector includes an actuator in the form of a solenoid comprising a coil and flux washers surrounding an inlet of the fuel injector and the valve member includes an upper portion configured as an armature acted on by a magnetic field generated when electric current is applied to the coil. In one embodiment, the fuel injector body includes an inlet for receiving pressurized gaseous fuel and the inlet also serves as a pole of the solenoid. The coil surrounds an axial gap between an end of the inlet facing the armature and the armature when the valve member is in the closed position, the flux washers including a cup-shaped magnetic upper flux washer surrounding the coil and a cylindrical, non-magnetic, wear resistant liner radially between the coil and the inlet and armature. The liner spanning the axial gap and guiding axial movement of the upper portion of the valve member between the closed and open positions. The non-magnetic, wear resistant liner also guiding magnetic flux generated by the coil through the pole and upper end of the valve member.

The valve member upper portion may define a fuel flow passage upstream of the valve surface allowing pressurized gaseous fuel to flow from the inlet to fill the valve chamber upstream of the valve seat surface when the valve member is in the closed position. The fuel flow passage may be concentric with an axial passage defined by the inlet and include radial openings allowing gaseous fuel to flow radially outward from the axial passage into the valve chamber. In one embodiment, the valve seat is attached to the fuel injector body by a separable, gas tight connection, allowing the valve seat surface to be removed and serviced or replaced and the valve seat reattached to the fuel injector body. The separable gas tight connection may be a threaded connection. The valve seat surface may be a surface of an annular insert received in a recess defined by the valve seat, said annular insert constructed from a compliant material selected to deform and absorb closure impact from the valve member contacting the valve seat surface in a closing direction of the valve. The annular insert may be constructed from material selected from polytetrafluoroethylene (PTFE), rubber, silicone, nitrile and plastic.

In one embodiment, the valve member surface is arranged on a downstream side of a radially projecting flange. The flange may be configured to deflect from an unloaded position to a loaded position to absorb closure impact when the valve member contacts the valve seat surface in the closing direction. Deflection of the flange from the unloaded to the loaded position results from the bias of a valve closure spring arranged to bias the valve member to the closed position and accumulation of pressurized gaseous fuel in the valve chamber acting on the valve member. Deflection of the flange from the unloaded to the loaded position may cause a sealing line between the valve member surface and the valve seat surface to move radially inward relative to a longitudinal axis of the fuel injector.

In one embodiment, the valve member is constructed from a ferro magnetic material and extends as a single, integral part from an upper end configured as an armature to a lower end including a valve member defining a valve member surface and including an extension projecting in the direction of fuel flow into an outflow passage. In other embodiments, the upper end of the valve member is constructed of ferro magnetic material and is configured as an armature, while a lower end including a valve member defining a valve member surface and including an extension projecting in the direction of fuel flow into an outflow passage is constructed of a different material and connected to the upper end of the valve member for movement therewith.

An object of the invention is to reduce the number of parts in a fuel injector valve for gaseous fuel, resulting in reduced manufacturing cost.

Another object of the invention is to provide a compact fuel injector valve with reduced flow resistance to facilitate delivery of large volumes of gaseous fuel to the intake path of an internal combustion engine in a short period of time.

A further object of the invention is to provide a fuel injector valve that generates a flow of gaseous fuel that enhances mixing of gaseous fuel with air present in the intake path of an internal combustion engine.

### BRIEF DESCRIPTION OF THE DRAWINGS

FIG. 1 is a longitudinal sectional view through an embodiment of an injector for gaseous fuel according to aspects of the disclosure;

FIG. 2 is a sectional perspective view of an embodiment of an injector for gaseous fuel according to aspects of the disclosure;

FIG. 3 is an enlarged cross-sectional view through a portion of a valve seat and valve member illustrating a compliant valve member according to aspects of the disclosure;

FIG. 4 is an enlarged cross-sectional view through a portion of a valve seat and valve member illustrating a valve member and valve seat surfaces according to aspects of the disclosure; and

FIG. 5 is an enlarged cross-sectional view through a portion of a valve seat and adjacent portions of a valve chamber illustrating a serviceable valve seat according to aspects of the disclosure.

### DETAILED DESCRIPTION

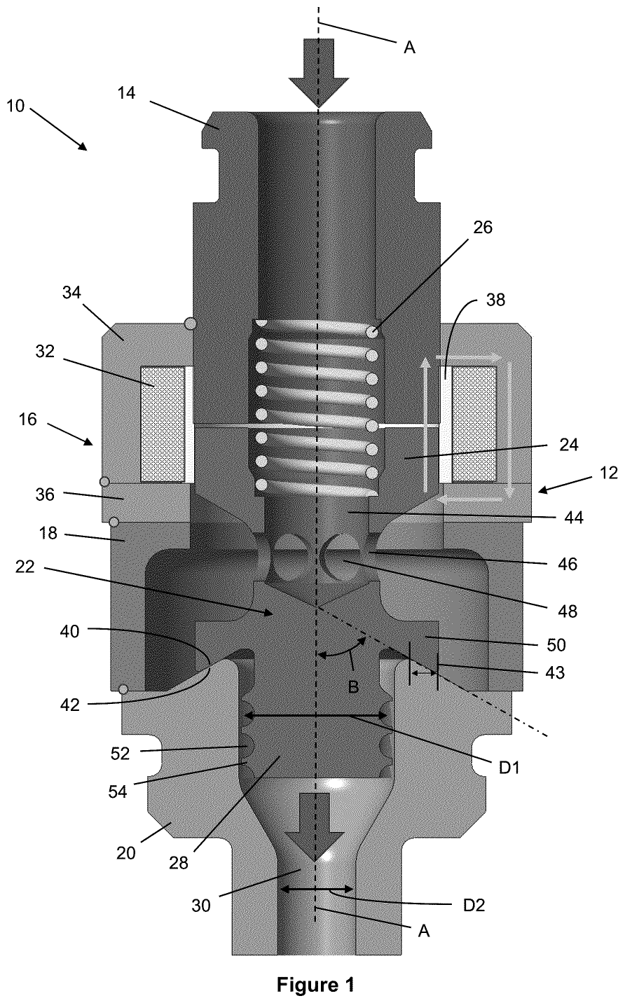

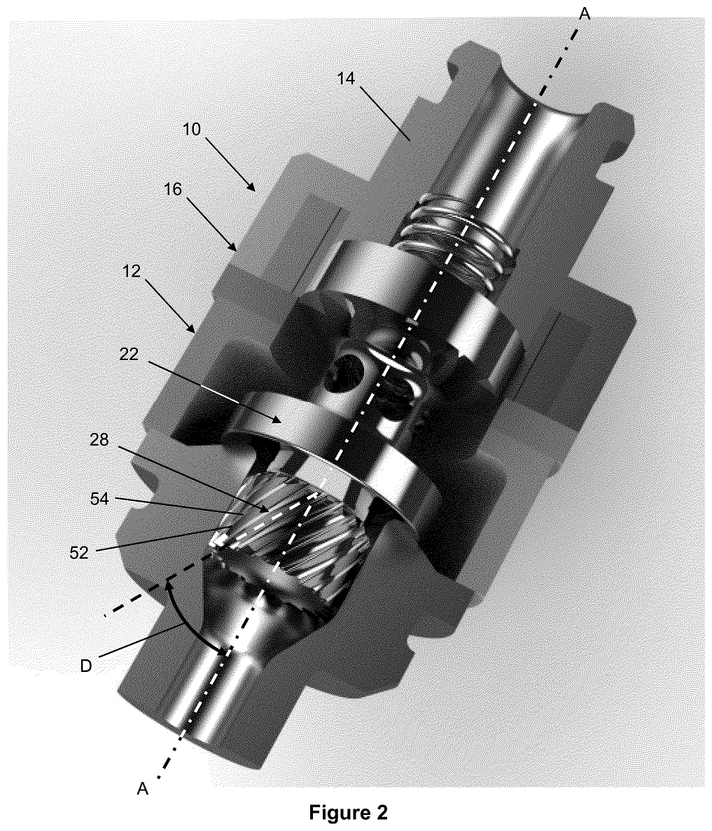

Embodiments of a fuel injector for gaseous fuel are illustrated in FIGS. 1 through 5. The disclosed fuel injector 10 includes an injector body 12 comprising an inlet 14, a coil assembly 16, a valve chamber 18 and a valve seat 20. According to aspects of the disclosure, the inlet 14 functions as a structural component of the fuel injector 10 where a fuel delivery conduit is connected and the inlet 14 also functions as a fixed magnetic pole of a solenoid generating actuation force for the fuel injector 10. A valve member 22 is arranged in the valve chamber 18 and is seated on top of the valve seat 20. The valve member 22 extends from the valve seat 20 toward the inlet 14 and includes an armature (upper) end 24 that functions as an armature of the solenoid. A bias spring 26 biases the valve member 22 toward a closed position against the valve seat 20 as shown in FIG. 1 forming a normally closed valve. The valve member 22 also includes a lower extension 28 received in an outflow passage 30 defined by the valve seat 20. Axial movement of the valve member 22 between a closed and open position is guided at the armature end 24 within the coil assembly and by the lower extension 28 within the outflow passage 30 downstream of the valve seat.

The coil assembly 16 comprises a solenoid; coil 32, a cup-shaped upper flux washer 34, a lower flux washer 36 and a cylindrical, non-magnetic liner 38. Application of electrical current to the solenoid coil 32 generates magnetic flux in a magnetic circuit defined by the upper flux washer, 34, lower flux washer 36, inlet 14, and armature end 24 of the valve member 22. The non-magnetic liner 38 guides magnetic flux radially inward into the lower end of the inlet 14 and armature end 24 of the valve member 22, maximizing attraction of the armature end 24 of the valve member 22 toward the inlet 14. The coil assembly 16 is configured to generate sufficient force to move the valve member 22 from the closed position shown in FIG. 1 to an open position where the upper end 24 of the valve member 22 is against the bottom of the inlet 14 and a valve member surface 40 of the valve member 22 is separated from a valve seat surface 42. The opening stroke of the valve member 22 is defined by the axial distance between the lower end of the inlet 14 and the valve seat surface 42. In the disclosed embodiment, the stroke (opening distance) of the valve member is between 500 microns and 1 mm. The non-magnetic liner 38 may be constructed of non-magnetic stainless steel. The non-magnetic liner and/or the adjacent surface of the armature end 24 of the valve member 22 may be coated to enhance abrasion resistance and reduce friction at the interface of the surfaces.

An embodiment of the disclosed fuel injector 10 may be assembled as follows: The valve seat 20, valve chamber 18 and coil assembly 16 are joined to each other by circumferential laser welds. The valve seat 20, valve chamber 18 and coil assembly are fixtured to maintain concentricity of these components until they are permanently joined by welding. The valve member 22 and bias spring 26 are inserted into the valve chamber 18, with the valve member surface 40 against the valve seat surface 42 and the armature end 24 surrounded by the non-magnetic liner 38 of the solenoid assembly 16. Finally, the inlet 14 is pressed through the upper flux washer 34 and non-magnetic liner 38 to an axial position corresponding to a desired opening stroke of the valve member 22. The inlet 14 is then welded to the upper flux washer 34. With the inlet 14, upper flux washer 34, lower flux washer 36, valve chamber 18 and valve seat 20 joined by circumferential laser welds, the injector body 12 is hermetically sealed to contain gaseous fuel.

The disclosed fuel injector 10 employs a pressure-balanced valve configuration where gaseous fuel pressure assists in maintaining closure of the valve member 22 and, when the valve member 22 is moved to its open position, gaseous fuel flow assists in moving the valve member 22 in the opening direction. A pressure balanced valve configuration reduces the force necessary to actuate the valve and allows selection of a smaller solenoid coil requiring less electrical power. As shown in FIG. 1, the armature end 24 of the valve member 22 defines a fuel flow passage 44 concentric with the axial passage in the inlet 14. The bias spring 26 is compressed between radially inward projecting shoulders of the inlet 14 and valve member 22. An axially intermediate portion 46 of the valve member 22 defines a plurality of openings 48 allowing gaseous fuel to flow into the valve chamber 18. The intermediate portion 46 of the valve member 22 has a reduced diameter to reduce the overall mass of the valve member and reduce the material cost of the valve member 22. When the valve member 22 is in the closed position shown in FIG. 1, gas pressure in the valve chamber 18 acts on an upper surface of a valve flange 50 to bias the valve member surface 40 against the valve seat surface 42. Gas pressure in the valve chamber 18 acts in combination with the force of the bias spring to generate a closure force on the valve member 22 that ensures a tight seal between the valve member surface 40 and valve seat surface 42. The bias force of the bias spring 26 can be reduced because gas pressure in the valve chamber 18 is also acting on the valve member 22 in the closing direction.

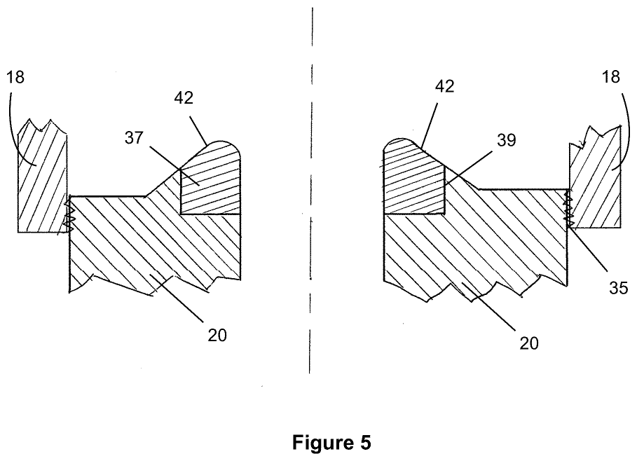

As shown in FIG. 4, in one embodiment the valve seat surface 42 and valve member surface 40 are concentric, conical surfaces inclined relative to a central longitudinal axis of the fuel injector 10. The inclination of the conical valve seat surface 42 and valve surface 40 cause a partial flow inversion gaseous fuel flowing through the fuel injector 10. Flow of gaseous fuel between the valve seat surface 42 and the valve surface 40 has a radial component toward a central axis of the fuel injector 10 and an axial component toward the inlet 14 of the fuel injector 10. The axial component of gaseous fuel flow toward the inlet 14 acts on the valve member 22 to assist movement of the valve member 22 in the opening direction. The surface area and inclination angle of the valve surface 40 valve seat surface 42 can be selected to provide a desired degree of lift to the valve member 22 at predetermined gaseous fuel pressures and rates of flow.

The surface area of the valve seat surface 42 is in part determined by the radial extent 43 of the valve seat surface 42 and the inclination angle B of the valve seat surface 42. In the embodiment of FIG. 1, the inclination angle B of the valve surface is an acute angle of approximately 60° relative to a longitudinal axis A-A of the fuel injector 10 measured in the direction of fuel flow. Acute inclination angles of between 30° and 80° can be used in the disclosed fuel injector 10. Smaller angles and a greater radial extent 43 of the valve seat surface 42 will tend to impart more axial momentum to the gaseous fuel flow to provide greater lift to the valve member 22, while larger angles and a smaller radial extent 43 of the valve seat surface 42 will tend to impart less axial momentum to the gaseous fuel flow and less lift to the valve member 22. Greater lift to the valve member 42 is obtained at the expense of resistance to fuel flow through the fuel injector, so the inclination angle B and radial extent 43 of the valve seat surface 42 are selected to provide a desired lift without adding significant resistance to fuel flow through the fuel injector 10.

The disclosed fuel injector 10 includes a lower valve extension 28 extending into an outflow passage 30 downstream of the valve seat surface 42. This lower extension 28 has an outside surface defining a plurality of parallel helical channels 52 between helical ribs 54. Outer ends of the helical ribs 54 are configured to be received in the outflow passage 30 and help to center the valve member 22 within the valve seat 20 and guide axial movement of the valve member 22 between the closed and open positions. The outer ends and/or the adjacent surface of the outflow passage 30 may be hard coated to reduce wear and friction at this sliding interface. The helical configuration of the ribs 54 and passages 52 impart a swirling movement to gaseous fuel as it passes out of the fuel injector 10. Organizing flow of gaseous fuel into a swirling motion avoids disorganized turbulence that can increase back pressure and promotes rapid mixing of the gaseous fuel as it joins air flow in the intake passage. The outflow passage 30 has a first diameter D1 where it surrounds the lower extension of the valve member 22 and a second, smaller downstream diameter D2. The smaller diameter D2 accelerates rotation and velocity of the swirling gaseous fuel and the difference between diameter D1 and D2 can be selected to provide a desired degree of acceleration.

The channels 52 on the lower extension 28 are oriented at an acute angle D relative to a longitudinal axis A-A of the fuel injector. The flow area and angular orientation of the channels 52 are selected to impart a pre-determined centripetal acceleration to the gaseous fuel as it passes through the outflow passage 30 immediately downstream of the valve surface 42. The acute angle D of the channels 52 may range from 10° to 45° relative to the longitudinal axis A-A of the fuel injector 10. The number of channels 52 may range from 10 to 30 around the circumference of the lower extension 28. The dimensions of each channel 52 are selected so that the combined flow area allows passage of a predetermined mass flow per second of gaseous fuel at a predetermined pressure. Fuel is further accelerated along a gradual narrowing of the outflow passage 30 from Diameter D1 to diameter D2 at the outlet end of the fuel injector 10. In combination, the configuration of the channels 52 and the outflow passage 30 impart a predetermined centripetal acceleration and flow velocity to the gaseous fuel that enhances mixing of the gaseous fuel with air entering the combustion chamber of the internal combustion engine. Thorough mixing of the gaseous fuel and air promotes complete and clean combustion of the fuel/air charge in the cylinder.

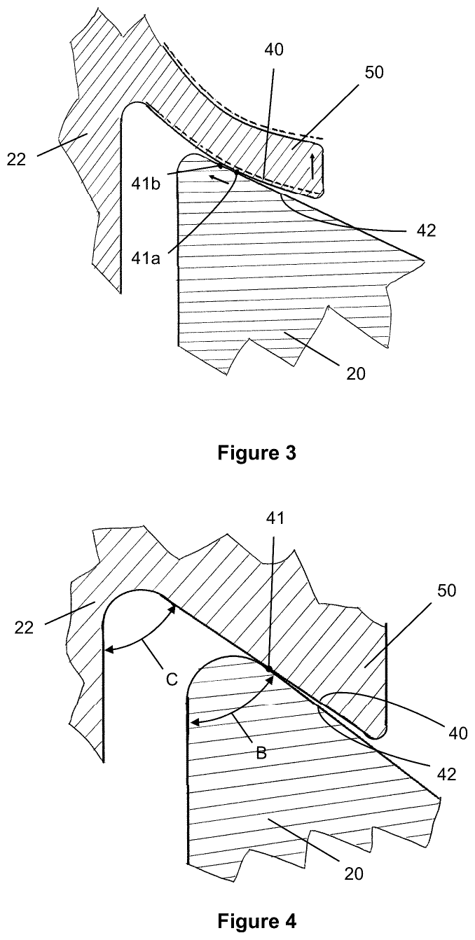

FIG. 3 illustrates an embodiment of a valve flange 50 configured to flex under closing pressure exerted by the bias spring 26 and pressurized fuel in the valve chamber 18. In the embodiment of FIG. 3, the valve member surface 42 is defined by an annular, large radius curved surface that meets the valve seat surface at a sealing line 41. When valve member surface 40 on the bottom of the valve flange 50 first contacts the valve seat surface 42, no gaseous pressure has accumulated in the valve chamber 18 and the valve flange 50 is in the position shown in solid lines. At first contact, the valve member surface 40 and the valve seat surface meet at sealing line 41a. As the valve flange 50 flexes toward the position shown in dashed lines to absorb closure impact and in response to increased gaseous pressure in the valve chamber 18, the seal line moves radially inward from 41a to 41b. Valve flange 50 can be designed to have a predetermined flexure by selecting the dimensions of the flange, as well as the radius of the valve member surface 40.

FIG. 4 illustrates an alternative configuration of a valve flange 50 incorporating a conical valve member surface 40. The acute angle C of the valve member surface 40 relative to a longitudinal axis A-A of the fuel injector 10 is larger than the acute angle B of the valve seat surface 42 relative to the longitudinal axis A-A. The valve member surface 42 and valve seat surface 40 meet at a sealing line 41. Over time, the valve seat surface 42 may wear, causing the sealing line 41 to shift radially outward.

FIG. 5 illustrates an alternative fuel injector configuration where the valve seat 20 has a threaded connection 35 to the valve chamber 18. This allows the valve seat 20 to be removed and serviced or replaced. Other forms of gas-tight, separable closure may also be used to connect the valve seat 20 to the valve chamber 18. In the embodiment of FIG. 5, the valve seat surface 42 is defined by an insert 37 received in a recess or gland 39 defined by the valve seat 20. The insert 37 may be designed to be removed from the valve seat 20 and replaced or may be permanently joined to the valve seat 20 for replacement along with the valve seat 20. The insert 37 is annular and may be constructed of any durable, compliant material from which seals are constructed such as PTFE, silicone, rubber, nitrile, plastic or the like. The insert 37 may be a custom shape as shown in FIG. 5 or may be in a standard shape such as an O-ring, with the gland 30 configured accordingly. This form of valve seat will absorb closure impact and extend the useful life of the fuel injector 10 by allowing the valve seat surface 42 to be periodically renewed.

Among the benefits and improvements disclosed herein, other objects and advantages of the disclosed embodiments will become apparent to those skilled in the art. Detailed embodiments of a gaseous fuel injector are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described, various embodiments may be readily combined as will be apparent to those skilled in the art.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

What is claimed:

1. A fuel injector for controlling delivery of gaseous fuel into an intake passage of an internal combustion engine, said fuel injector comprising:
a fuel injector body defining a fuel flow passage extending in a direction of fuel flow from an inlet to an outlet;
an actuator;
an annular valve seat in a valve chamber, said valve seat having a valve seat surface inclined relative to the direction of fuel flow;
an outflow passage having a first diameter D1 immediately downstream of the valve seat surface, and a second diameter D2 downstream of the first diameter D1, said second diameter D2 being smaller than the first diameter D1;
a valve member having a valve member surface complementary to the valve seat surface, said valve member including an extension projecting into the outflow passage, said extension having an outside surface comprising a plurality of helical ribs defining a plurality of helical channels,
wherein said valve member reciprocates between a closed position where said valve member surface is mated to said valve seat surface and an open position where said valve surface is separated from said valve seat surface allowing gaseous fuel to flow past the valve seat surface and into said outflow passage, said valve member moved from said closed position to said open position by said actuator, pressure of gaseous fuel in the valve chamber acting to bias said valve member toward the valve seat when said valve member is in the closed position and the inclination of said valve seat surface causing gaseous fuel to flow against the direction of fuel flow and act on the valve member in an opening direction when said valve member is in the open position, said helical ribs bearing on an inside surface of the outflow passage to guide movement of the valve member and said helical channels imparting a centripetal acceleration to said gaseous fuel as it flows through the outflow passage.

2. The fuel injector of claim 1, wherein said valve seat surface is a conical surface and said valve member surface is a conical surface concentric with said valve seat surface.

3. The fuel injector of claim 1, wherein said valve seat surface is a conical surface oriented at an acute angle relative to a longitudinal axis of the fuel injector, said acute angle measured in the direction of fuel flow.

4. The fuel injector of claim 1, wherein said actuator is a solenoid comprising a coil and flux washers surrounding an inlet of the fuel injector and said valve member includes an upper portion configured as an armature acted on by a magnetic field generated when electric current is applied to the coil.

5. The fuel injector of claim 4, wherein said valve member upper portion defines a fuel flow passage upstream of the valve surface allowing pressurized gaseous fuel to flow from the inlet to fill the valve chamber upstream of the valve seat surface when the valve member is in the closed position.

6. The fuel injector of claim 4, comprising an inlet receiving pressurized gaseous fuel, wherein said inlet also serves as a pole of the solenoid.

7. The fuel injector of claim 6, wherein the coil surrounds an axial gap between an end of the inlet facing the armature and the armature when the valve member is in the closed position, said flux washers including a cup-shaped magnetic upper flux washer surrounding the coil and a cylindrical, non-magnetic, wear resistant liner radially between the coil and the inlet and armature, said liner spanning the axial gap and guiding axial movement of the upper portion of the valve member between the closed and open positions.

8. The fuel injector of claim 2, wherein the valve member surface is oriented at a first acute angle relative to a longitudinal axis of the fuel injector and the valve seat surface is oriented at a second acute angle relative to the longitudinal axis of the fuel injector, said first acute angle being greater than said second acute angle, said valve member surface meeting said valve seat surface at a sealing line.

9. The fuel injector of claim 1, wherein the valve member surface is an annular surface having a large radius of curvature in a plane parallel to a longitudinal axis of the fuel injector, said valve member surface meeting the valve seat surface at a sealing line.

10. The fuel injector of claim 1, wherein the valve seat is attached to the fuel injector body by a separable, gas tight connection, the valve seat surface can be replaced and the valve seat reattached to the fuel injector body.

11. The fuel injector of claim 1, wherein the valve seat surface is a surface of an annular insert received in a recess defined by the valve seat, said annular insert constructed from a compliant material selected to deform and absorb closure impact from the valve member contacting the valve seat surface in a closing direction of the valve.

12. The fuel injector of claim 11, wherein the annular insert is constructed from material selected from PTFE, rubber, silicone, nitrile and plastic.

13. The fuel injector of claim 1, wherein the valve member defines a fuel flow passage concentric with an axial passage defined by the inlet, said fuel flow passage including radial openings allowing gaseous fuel to flow radially outward from the axial passage into the valve chamber.

14. The fuel injector of claim 10, wherein the separable, gas tight connection is a threaded connection.
